(19) United States
(12) Patent Application Publication
(10) Pub. No.: US 2023/0368649 A1
(43) Pub. Date: Nov. 16, 2023

(54) METHOD AND SYSTEM FOR AUTOMATIC SELF TEST FOR THE FIRE SYSTEM

(71) Applicant: Carrier Corporation, Palm Beach Gardens, FL (US)

(72) Inventors: Saikrishna Gajula, Hyderabad (IN); Ramakrishna Pulluru, Hyderabad (IN); Rizwana Begum, Hyderabad (IN); Ramesh Lingala, Hyderabad (IN)

(21) Appl. No.: 18/314,562

(22) Filed: May 9, 2023

Related U.S. Application Data
(60) Provisional application No. 63/340,267, filed on May 10, 2022.

(51) Int. Cl. G08B 29/14

(52) U.S. Cl. CPC G08B 29/145

(57) ABSTRACT

A method of testing a fire detector, the method including receiving a self-test request at the fire detector; initiating a self-test on the fire detector; emitting a test sound from the fire detector; detecting the test sound using a voice activated assistant device or a thermostat; analyzing the test sound; determining self-test results based on the test sound; and conveying the self-test results to an individual.

### CROSS-REFERENCE TO RELATED APPLICATIONS

This applications claims the priority of U.S. Provisional Application No. 63/340,267 filed May 10, 2022, all of which are incorporated herein by reference in their entirety.

### BACKGROUND

The embodiments herein generally relate to fire detecting devices and more specifically, a method and apparatus to test fire detecting devices.

Fire detection devices conventionally require an individual to manually push a button on the fire detection device in order to verify that the fire detection device is working properly. This task often requires an individual to get up on a ladder in order to reach the fire detection device that is typically located on the ceiling. This is an arduous task and a more efficient solution is greatly desired.

### BRIEF DESCRIPTION

According to an embodiment, a method of testing a fire detector includes receiving a self-test request at the fire detector; initiating a self-test on the fire detector; emitting a test sound from the fire detector; detecting the test sound using a voice activated assistant device or a thermostat; analyzing the test sound; determining self-test results based on the test sound; and conveying the self-test results to an individual.

In addition to one or more of the features described above, or as an alternative, further embodiments of may include wherein prior to the receiving the self-test request at the fire detector, the method further includes receiving the self-test request from the individual using the voice activated assistant device or the thermostat; and transmitting the self-test request to the fire detector.

In addition to one or more of the features described above, or as an alternative, further embodiments of may include wherein prior to the receiving the self-test request at the fire detector, the method further includes receiving the self-test request from the individual using a computer application on a computing device, transmitting the self-test request to a cloud-based controller; and transmitting the self-test request to the fire detector from the cloud-based controller.

In addition to one or more of the features described above, or as an alternative, further embodiments of may include wherein prior to the receiving the self-test request at the fire detector, the method further includes initiating the self-test request on a cloud-based controller; and transmitting the self-test request to the fire detector from the cloud-based controller.

In addition to one or more of the features described above, or as an alternative, further embodiments of may include wherein the test sound is conveyed to a cloud-based controller to analyze the test sound and determine the self-test results.

In addition to one or more of the features described above, or as an alternative, further embodiments of may include wherein the self-test request is received by the voice activated assistant device.

In addition to one or more of the features described above, or as an alternative, further embodiments of may include wherein the self-test request is received by the thermostat.

In addition to one or more of the features described above, or as an alternative, further embodiments of may include wherein the test sound is detected by the voice activated assistant device.

In addition to one or more of the features described above, or as an alternative, further embodiments of may include wherein the test sound is detected by the thermostat.

In addition to one or more of the features described above, or as an alternative, further embodiments of may include wherein the conveying the self-test results to the individual further includes displaying the self-test results on a display device of a computing device of the individual.

In addition to one or more of the features described above, or as an alternative, further embodiments of may include wherein the conveying the self-test results to the individual further includes audibly stating the self-test results to the individual using the voice activated assistant device.

In addition to one or more of the features described above, or as an alternative, further embodiments of may include wherein the conveying the self-test results to the individual further includes audibly stating the self-test results to the individual using the thermostat.

In addition to one or more of the features described above, or as an alternative, further embodiments of may include wherein the self-test includes verifying hardware functional integrity of the fire detector.

According to another embodiment, a computer program product tangibly embodied on a non-transitory computer readable medium includes instructions that, when executed by a processor, cause the processor to perform operations including receiving a self-test request at a fire detector; initiating a self-test on the fire detector; emitting a test sound from the fire detector; detecting the test sound using a voice activated assistant device or a thermostat; analyzing the test sound; determining self-test results based on the test sound; and conveying the self-test results to an individual.

In addition to one or more of the features described above, or as an alternative, further embodiments of may include wherein prior to the receiving the self-test request at the fire detector, the operations further including receiving the self-test request from the individual using the voice activated assistant device or the thermostat; and transmitting the self-test request to the fire detector.

In addition to one or more of the features described above, or as an alternative, further embodiments of may include wherein prior to the receiving the self-test request at the fire detector, the operations further include receiving the self-test request from the individual using a computer application on a computing device, transmitting the self-test request to a cloud-based controller; and transmitting the self-test request to the fire detector from the cloud-based controller.

In addition to one or more of the features described above, or as an alternative, further embodiments of may include wherein prior to the receiving the self-test request at the fire detector, the operations further include initiating the self-test request on a cloud-based controller; and transmitting the self-test request to the fire detector from the cloud-based controller.

In addition to one or more of the features described above, or as an alternative, further embodiments of may include wherein the test sound is conveyed to a cloud-based controller to analyze the test sound and determine the self-test results.

In addition to one or more of the features described above, or as an alternative, further embodiments of may include wherein the self-test request is received by the voice activated assistant device.

In addition to one or more of the features described above, or as an alternative, further embodiments of may include wherein the self-test request is received by the thermostat.

In addition to one or more of the features described above, or as an alternative, further embodiments of may include wherein the test sound is detected by the voice activated assistant device.

Technical effects of embodiments of the present disclosure include the ability to detect a test sound from a fire detector using a voice activated assistant device or a thermostat.

The foregoing features and elements may be combined in various combinations without exclusivity, unless expressly indicated otherwise. These features and elements as well as the operation thereof will become more apparent in light of the following description and the accompanying drawings. It should be understood, however, that the following description and drawings are intended to be illustrative and explanatory in nature and non-limiting.

### BRIEF DESCRIPTION OF THE DRAWINGS

The following descriptions should not be considered limiting in any way. With reference to the accompanying drawings, like elements are numbered alike:

FIG. 1 is a schematic diagram of fire detector system, according to an embodiment of the present disclosure; and

FIG. 2 is a flow process illustrating a method of testing a fire detector, according to an embodiment of the present disclosure.

### DETAILED DESCRIPTION

A detailed description of one or more embodiments of the disclosed apparatus and method are presented herein by way of exemplification and not limitation with reference to the Figures.

The embodiments of the method and apparatus detailed herein relate to a method to test a fire detection device using a voice activated assistant or thermostat.

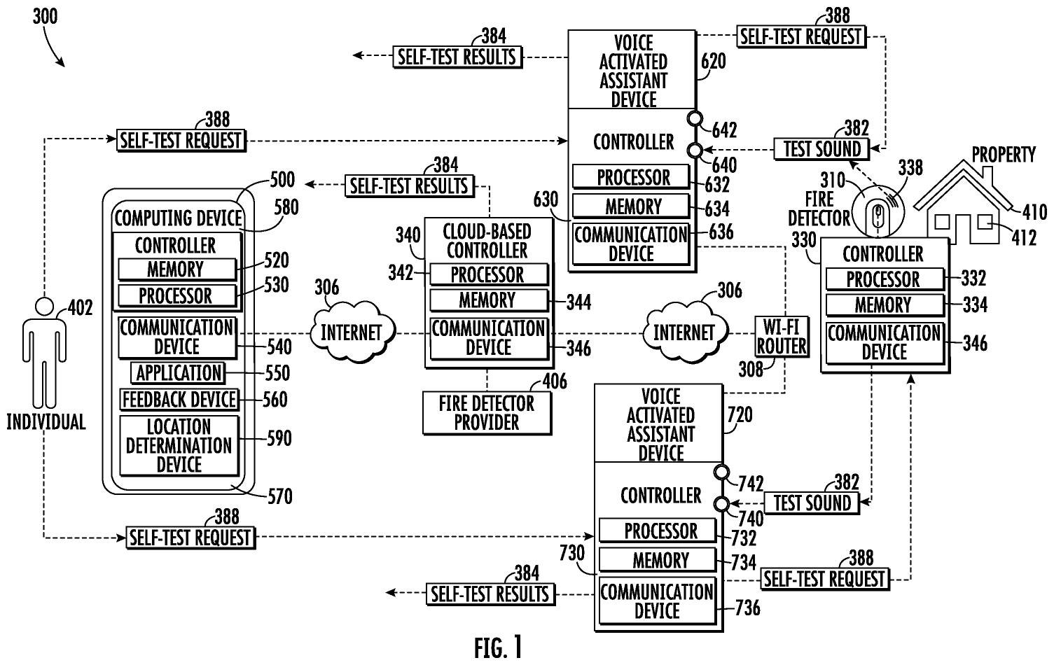

Referring now to FIG. 1, a schematic diagram of a fire detection system 300 is illustrated, according to an embodiment of the present disclosure. It should be appreciated that, although particular systems are separately defined in the schematic block diagrams, each or any of the systems may be otherwise combined or separated via hardware and/or software.

The fire detection system 300 includes the cloud-based controller 340, a fire detector 310 and a computer application 550 installed or accessible to a computing device 500. The computer application 550 may be accessible from the computing device 500, such as, for example, a software-as-as service or a website. The computer application 550 may be in communication with the cloud database via the internet 306. The fire detection system 300 may also include at least one of a voice activated assistant device 620 or a thermostat 720.

The fire detector 310 may be configured to detect a fire within the property 410. The fire detector 310 may be a smoke detector, a CO₂ detector, a CO detector, a heat sensor, or any other fire detector known to one of skill in the art. The fire detector 310 may be an internet of things (IoT) connected device. The property 410 may be a home, an apartment, a garage, a room, a shed, a storage unit, a car, a vehicle, land, or any other area known to one of skill in the art that may need to be protected from fire. The property 410 may be owned by an individual 402, rented by the individual 402, in possession of an individual 402, in control of the individual 402, leased by the individual 402, or mortgaged by the individual 402. The individual 402 may be a person, an organization, a group, a partnership, a company, or a corporation.

The property 410 may have one or more fire detectors 310. The one or more fire detectors 310 may each be in communication with each other. In an embodiment there may be at least one fire detector 310 located in each room 412 of the property 410.

The fire detection system 300 may also include a voice activated assistant device 620. The voice activated assistant device 620 may be a Google Home, an Amazon Alexa, or any other similar device. The voice activated assistant device 620 may include microphone 640 configured to detect sound waves and a speaker 642 configured to emit sound waves.

The voice activated assistant device 620 may be a standalone device or embedded in the thermostat 720. The voice activated assistant device 620 includes a controller 630 that is configured to communicate with the computer application 550 and the cloud-based controller 340. The controller 630 may be a controller dedicated solely for the voice activated assistant device 620 or shared with the thermostat 720.

The controller 630 may be an electronic controller including a processor 632 and an associated memory 634 comprising computer-executable instructions (i.e., computer program product) that, when executed by the processor 632, cause the processor 632 to perform various operations. The processor 632 may be, but is not limited to, a single-processor or multi-processor system of any of a wide array of possible architectures, including field programmable gate array (FPGA), central processing unit (CPU), application specific integrated circuits (ASIC), digital signal processor (DSP) or graphics processing unit (GPU) hardware arranged homogenously or heterogeneously. The memory 634 may be but is not limited to a random access memory (RAM), read only memory (ROM), or other electronic, optical, magnetic or any other computer readable medium.

The controller 630 also includes a communication device 636. The communication device 636 may be capable of wireless communication including but not limited to Wi-Fi, Bluetooth, BLE, Ultra-Wideband, Zigbee, Z-Wave, Sub-GHz RF Channel, cellular, satellite, or any other wireless signal known to one of skill in the art. The communication device 636 may be configured to communicate with the cloud-based controller 340 through the internet 306. Alternatively, or additionally, the communication device 636 may be configured to communicate directly with the cloud-based controller 340. The communication device 636 may be configured to communicate with other voice activated assistant device 620 through the internet 306 or directly through wireless communication. The communication device 636 may be connected to the internet 306 through a Wi-Fi-router 308.

There may be multiple different rooms 412 in the property 410 and each room 412 may include a voice activated assistant device 620.

The fire detection system 300 may also include a thermostat 720 configured to control a heating, ventilation, and air conditioning (HVAC) system (not shown) at the property 410. The thermostat 720 may include microphone 740 configured to detect sound waves and a speaker 742 configured to emit sound waves. The voice activated assistant device 620 may be integrated into the thermostat 720.

The thermostat 720 includes a controller 730 that is configured to communicate with the computer application 550 and the cloud-based controller 340. The controller 730 may be a controller dedicated solely for the thermostat 720 or shared with the voice activated assistant device 620 if combined. The thermostat 720 may be a standalone device.

The controller 730 may be an electronic controller including a processor 732 and an associated memory 734 comprising computer-executable instructions (i.e., computer program product) that, when executed by the processor 732, cause the processor 732 to perform various operations. The processor 732 may be, but is not limited to, a single-processor or multi-processor system of any of a wide array of possible architectures, including field programmable gate array (FPGA), central processing unit (CPU), application specific integrated circuits (ASIC), digital signal processor (DSP) or graphics processing unit (GPU) hardware arranged homogenously or heterogeneously. The memory 734 may be but is not limited to a random access memory (RAM), read only memory (ROM), or other electronic, optical, magnetic or any other computer readable medium.

The controller 730 also includes a communication device 736. The communication device 736 may be capable of wireless communication including but not limited to Wi-Fi, Bluetooth, BLE, Ultra-Wideband, Zigbee, Z-Wave, Sub-GHz RF Channel, cellular, satellite, or any other wireless signal known to one of skill in the art. The communication device 736 may be configured to communicate with the cloud-based controller 340 through the internet 306. Alternatively, or additionally, the communication device 736 may be configured to communicate directly with the cloud-based controller 340. The communication device 736 may be configured to communicate with other thermostats 720 through the internet 306 or directly through wireless communication. The communication device 736 may be connected to the internet 306 through a Wi-Fi-router 308.

There may be multiple different rooms 412 in the property 410 and one or more rooms 412 may include a thermostat 720.

The fire detector 310 includes a controller 330 that is configured to communicate with the computer application 550 and the cloud-based controller 340. The controller 330 may be a controller dedicated solely for the fire detector 310. The controller 330 may be an electronic controller including a processor 332 and an associated memory 334 comprising computer-executable instructions (i.e., computer program product) that, when executed by the processor 332, cause the processor 332 to perform various operations. The processor 332 may be, but is not limited to, a single-processor or multi-processor system of any of a wide array of possible architectures, including field programmable gate array (FPGA), central processing unit (CPU), application specific integrated circuits (ASIC), digital signal processor (DSP) or graphics processing unit (GPU) hardware arranged homogenously or heterogeneously. The memory 334 may be but is not limited to a random access memory (RAM), read only memory (ROM), or other electronic, optical, magnetic or any other computer readable medium.

The controller 330 also includes a communication device 336. The communication device 336 may be capable of wireless communication including but not limited to Wi-Fi, Bluetooth, BLE, Ultra-Wideband, Zigbee, Z-Wave, Sub-GHz RF Channel, cellular, satellite, or any other wireless signal known to one of skill in the art. The communication device 336 may be configured to communicate with the cloud-based controller 340 through the internet 306. Alternatively, or additionally, the communication device 336 may be configured to communicate directly with the cloud-based controller 340. The communication device 336 may be configured to communicate with another fire detector over a wired and/or wireless connection. The communication device 336 may be connected to the internet 306 through a Wi-Fi-router 308. The fire detector 310 can also communicate with other fire detectors that lack Wi-Fi capability, using an RF protocol. In example embodiments, a fire detector lacking Wi-Fi capability may connect to the network 306 via the thermostat 720 and/or the voice activated assistant device 620 using an RF protocol.

The controller 330 may be configured to communicate with the voice activated assistant device 620 and/or the thermostat 720 through short-range wireless communication, such as for example Bluetooth, BLE, Ultra-Wideband, Zigbee, Z-Wave, Sub-GHz RF Channel, or any other short-range wireless signal known to one of skill in the art.

The fire detector 310 may include a speaker 338 configured to emit sound waves. The speaker 338 may be configured to emit a test sound 382, as will be discussed further herein.

The cloud-based controller 340 may belong to and/or be managed by a fire detector provider 406, such as, for example a manufacture of the fire detector 310 or an aftermarket support company for the fire detector 310.

The cloud-based controller 340 may be a remote or local computer device that includes a processor 342 and an associated memory 344 comprising computer-executable instructions (i.e., computer program product) that, when executed by the processor 342, cause the processor 342 to perform various operations. The processor 342 may be, but is not limited to, a single-processor or multi-processor system of any of a wide array of possible architectures, including field programmable gate array (FPGA), central processing unit (CPU), application specific integrated circuits (ASIC), digital signal processor (DSP) or graphics processing unit (GPU) hardware arranged homogenously or heterogeneously. The memory 344 may be but is not limited to a random access memory (RAM), read only memory (ROM), or other electronic, optical, magnetic or any other computer readable medium.

The cloud-based controller 340 also includes a communication device 346. The communication device 346 may be capable of communication with the internet 306. The communication device 346 may be configured to communicate with the computing device 500 through the internet 306. The communication device 346 may be a software module that handles communications to-and-from the computer application 550 or to-and-from the controller 330.

The computing device 500 may be a desktop computer, a laptop computer, or a mobile computing device that is typically carried by a person, such as, for example a phone, a smart phone, a PDA, a smart watch, a tablet, a laptop, or any other mobile computing device known to one of skill in the art.

The computing device 500 includes a controller 510 configured to control operations of the computing device 500. The controller 510 may be an electronic controller including a processor 530 and an associated memory 520 comprising computer-executable instructions (i.e., computer program product) that, when executed by the processor 530, cause the processor 530 to perform various operations. The processor 530 may be, but is not limited to, a single-processor or multi-processor system of any of a wide array of possible architectures, including field programmable gate array (FPGA), central processing unit (CPU), application specific integrated circuits (ASIC), digital signal processor (DSP) or graphics processing unit (GPU) hardware arranged homogenously or heterogeneously. The memory 520 may be but is not limited to a random access memory (RAM), read only memory (ROM), or other electronic, optical, magnetic or any other computer readable medium.

The computing device 500 includes a communication device 540 configured to communicate with the internet 306 through one or more wireless signals. The one or more wireless signals may include Wi-Fi, Bluetooth, BLE, Ultra-Wideband, Zigbee, Z-Wave, Sub-GHz RF Channel, cellular, satellite, or any other wireless signal known to one of skill in the art. The computing device 500 is configured to communicate with the cloud-based controller 340 through the internet 306. Alternatively, the computing device 500 may be connected to the internet 306 through a hardwired connection. The computing device 500 may be configured to communicate directly with the fire detector 310 through a short-range wireless signal 360, including, but not limited to, Wi-Fi, Bluetooth, BLE, Ultra-Wideband, Zigbee, Z-Wave, Sub-GHz RF Channel, or any other wireless communication method known to one of skill in the art.

The computing device 500 may include a display device 580, such as for example a computer display, an LCD display, an LED display, an OLED display, a touchscreen of a smart phone, tablet, or any other similar display device known to one of the skill in the art. A user operating the computing device 500 is able to view the computer application 550 through the display device 580.

The computing device 500 includes an input device 570 configured to receive a manual input from a user (e.g., human being) of computing device 500. The input device 570 may be a keyboard, a touch screen, a joystick, a knob, a touchpad, one or more physical buttons, a microphone configured to receive a voice command, a camera or sensor configured to receive a gesture command, an inertial measurement unit configured to detect a shake of the computing device 500, or any similar input device known to one of skill in the art. The user operating the computing device 500 is able to enter data into the computer application 550 through the input device 570. The input device 570 allows the user operating the computing device 500 to data into the computer application 550 via a manual input to input device 570. For example, the user may respond to a prompt on the display device 580 by entering a manual input via the input device 570. In one example, the manual input may be a touch on the touchscreen. In an embodiment, the display device 580 and the input device 570 may be combined into a single device, such as, for example, a touchscreen.

The computing device 500 may also include a feedback device 560. The feedback device 560 may activate in response to a manual input via the input device 570. The feedback device 560 may be a haptic feedback vibration device and/or a speaker emitting a sound. The feedback device 560 may activate to confirm that the manual input entered via the input device 570 was received via the computer application 550. For example, the feedback device 560 may activate by emitting an audible sound or vibrate the computing device 500 to confirm that the manual input entered via the input device 570 was received via the computer application 550.

The computing device 500 may also include a location determination device 590 that may be configured to determine a location of the computing device 500 using cellular signal triangulation, a global position satellite (GPS), or any location termination method known to one of skill in the art.

An individual 402 may ask the voice activated assistant device 620 in a self-test request 388 to test the fire detector 310 using an audible voice command. Once, the voice activated assistant device 620 receives the self-test request 388, the voice activated assistant device 620 will relay the self-test request 388 to the fire detector 310 through a short-range wireless signal. Once the fire detector 310 receives the self-test request 388, the fire detector 310 will initiate the self-test to verify hardware functional integrity and/or battery life of the fire detector 310. During the self-test, the fire detector 310 will emit a test sound 382. The test sound 382 may be some special sound pattern/T3 pattern/T4 pattern. The T3 pattern and the T4 pattern are the detector alarm sounder patterns. The T3 pattern may include three intermittent beeps followed by a period of silence. Carbon monoxide detectors emit a T4 alarm including four intermittent beeps followed by a period of silence.

The voice activated assistant device 620 is configured to listen for or detect the test sound 382. The voice activated assistant device 620 is configured to send the test sound 382 to the cloud-based controller 340 for analysis and the cloud-based control 340 is configured to determine the self-test results 384 based on the test sound 382. The self-test results 384 may indicate whether the fire detector 310 is operating properly based on the test sound 382. The self-test results 384 may then be conveyed to the individual 402. The self-test results 384 may be conveyed to the individual 402 by being transmitted to the computing device 500 and displayed on a display device 580 on the computing device 500. The self-test results 384 may be conveyed to the individual 402 by being transmitted to the voice activated assistant device 620 and then audibly conveyed to the individual 402 from the voice activated assistant device 620.

Similarly, an individual 402 may ask the thermostat 720 in a self-test request 388 to test the fire detector 310 using an audible voice command. Once, the thermostat 720 receives the self-test request 388, the thermostat 720 will relay the self-test request 388 to the fire detector 310 through a short-range wireless signal. Once the fire detector 310 receives the self-test request 388, the fire detector 310 will initiate the self-test to check the functionality and/or battery life of the fire detector 310. During the self-test, the fire detector 310 will emit a test sound 382. The test sound 382 may be some special sound pattern/T3 pattern/T4 pattern. The thermostat 720 is configured to listen for or detect the test sound 382. The thermostat 720 is configured to send the test sound 382 to the cloud-based controller 340 for analysis and the cloud-based control 340 is configured to determine the self-test results 384 based on the test sound 382. The self-test results 384 may indicate whether the fire detector 310 is operating properly based on the test sound 382. The self-test results 384 may then be conveyed to the individual 402. The self-test results 384 may be conveyed to the individual 402 by being transmitted to the computing device 500 and displayed on a display device 580 on the computing device 500. The self-test results 384 may be conveyed to the individual 402 by being transmitted to the thermostat 720 and then audibly conveyed to the individual 402 from the thermostat 720.

Alternatively, an individual 402 may initiate a self-test request 388 using the computer application 550 by entering a manual input via an input device 570 of the computing device 500. The computer application 550 may transmit the self-test request 388 to the cloud-based controller 340 and the cloud-based controller 340 may transmit the self-test request 388 directly to the fire detector 310. Once the fire detector 310 receives the self-test request 388, the fire detector 310 will initiate the self-test to check the functionality and/or battery life of the fire detector 310. During the self-test, the fire detector 310 will emit a test sound 382. The test sound 382 may be some special sound pattern/T3 pattern/T4 pattern. The voice activated assistant device 620 is configured to listen for or detect the test sound 382. The voice activated assistant device 620 is configured to send the test sound 382 to the cloud-based controller 340 for analysis and the cloud-based control 340 is configured to determine the self-test results 384 based on the test sound 382. The self-test results 384 may indicate whether the fire detector 310 is operating properly based on the test sound 382. The self-test results 384 may then be conveyed to the individual 402. The self-test results 384 may be conveyed to the individual 402 by being transmitted to the computing device 500 and displayed on a display device 580 on the computing device 500. The self-test results 384 may be conveyed to the individual 402 by being transmitted to the voice activated assistant device 620 and then audibly conveyed to the individual 402 from the voice activated assistant device 620.

Similarly, an individual 402 may initiate a self-test request 388 using the computer application 550 by entering a manual input via an input device 570 of the computing device 500. The computer application 550 may transmit the self-test request 388 to the cloud-based controller 340 and the cloud-based controller 340 may transmit the self-test request 388 directly to the fire detector 310. Once the fire detector 310 receives the self-test request 388, the fire detector 310 will initiate the self-test to check the functionality and/or battery life of the fire detector 310. During the self-test, the fire detector 310 will emit a test sound 382. The test sound 382 may be some special sound pattern/T3 pattern/T4 pattern. The thermostat 720 is configured to listen for or detect the test sound 382. The thermostat 720 is configured to send the test sound 382 to the cloud-based controller 340 for analysis and the cloud-based control 340 is configured to determine the self-test results 384 based on the test sound 382. The self-test results 384 may indicate whether the fire detector 310 is operating properly based on the test sound 382. The self-test results 384 may then be conveyed to the individual 402. The self-test results 384 may be conveyed to the individual 402 by being transmitted to the computing device 500 and displayed on a display device 580 on the computing device 500. The self-test results 384 may be conveyed to the individual 402 by being transmitted to the thermostat 720 and then audibly conveyed to the individual 402 from the thermostat 720.

Alternatively, the cloud-based controller 340 initiate a self-test request 388 and then transmit a self-test request 388 directly to the fire detector 310. The self-test request 388 may be initiated by the cloud-based controller 340 periodically based on a set schedule or sporadically. Once the fire detector 310 receives the self-test request 388, the fire detector 310 will initiate the self-test to check the functionality and/or battery life of the fire detector 310. During the self-test, the fire detector 310 will emit a test sound 382. The test sound 382 may be some special sound pattern/T3 pattern/T4 pattern. The voice activated assistant device 620 is configured to listen for or detect the test sound 382. The voice activated assistant device 620 is configured to send the test sound 382 to the cloud-based controller 340 for analysis and the cloud-based control 340 is configured to determine the self-test results 384 based on the test sound 382. The self-test results 384 may indicate whether the fire detector 310 is operating properly based on the test sound 382. The self-test results 384 may then be conveyed to the individual 402. The self-test results 384 may be conveyed to the individual 402 by being transmitted to the computing device 500 and displayed on a display device 580 on the computing device 500. The self-test results 384 may be conveyed to the individual 402 by being transmitted to the voice activated assistant device 620 and then audibly conveyed to the individual 402 from the voice activated assistant device 620.

Similarly, the cloud-based controller 340 initiate a self-test request 388 and then transmit a self-test request 388 directly to the fire detector 310. The self-test request 388 may be initiated by the cloud-based controller 340 periodically based on a set schedule or sporadically. Once the fire detector 310 receives the self-test request 388, the fire detector 310 will initiate the self-test to check the functionality and/or battery life of the fire detector 310. During the self-test, the fire detector 310 will emit a test sound 382. The test sound 382 may be some special sound pattern/T3 pattern/T4 pattern. The thermostat 720 is configured to listen for or detect the test sound 382. The thermostat 720 is configured to send the test sound 382 to the cloud-based controller 340 for analysis and the cloud-based control 340 is configured to determine the self-test results 384 based on the test sound 382. The self-test results 384 may indicate whether the fire detector 310 is operating properly based on the test sound 382. The self-test results 384 may then be conveyed to the individual 402. The self-test results 384 may be conveyed to the individual 402 by being transmitted to the computing device 500 and displayed on a display device 580 on the computing device 500. The self-test results 384 may be conveyed to the individual 402 by being transmitted to the thermostat 720 and then audibly conveyed to the individual 402 from the thermostat 720.

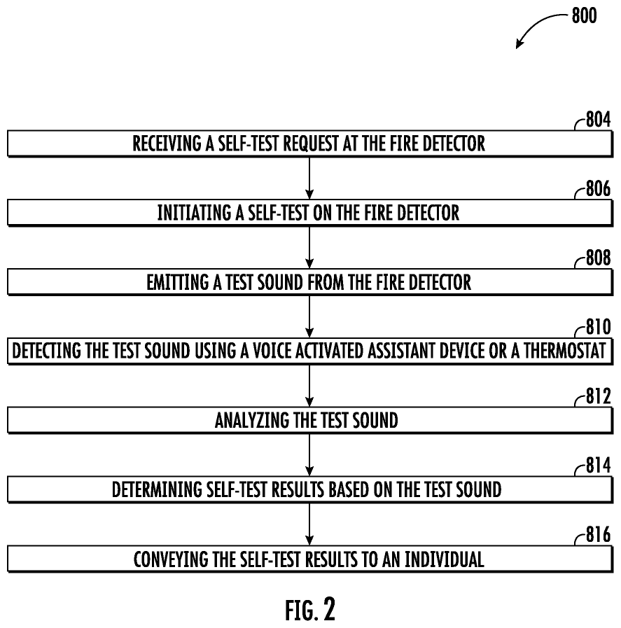

Referring to FIG. 2, within continued references to FIG. 1, a flow diagram illustrating a method 800 of testing a fire detector 310 is illustrated, in accordance with an embodiment of the present disclosure. In an embodiment, the method 800 may be performed by the fire detection system 300.

At block 804, a self-test request 388 is received at the fire detector 310. At block 806, a self-test is initiated on the fire detector 310. At block 808, a test sound 382 is emitted from the fire detector 310. At block 810, the test sound 382 is detected using a voice activated assistant device 620 or a thermostat 720. In one embodiment, the test sound 382 is detected by the voice activated assistant device 620. In another embodiment, the test sound 382 is detected by the thermostat 720. At block 812, the test sound 382 is analyzed.

At block 814, self-test results 384 are determined based on the test sound 382. In one embodiment, the test sound 382 is conveyed to a cloud-based controller 340 to analyze the test sound 382 and determine the self-test results 384.

At block 816, the self-test results 384 are conveyed to an individual 402. The self-test results 384 may be conveyed to an individual 402 by displaying the self-test results 384 on a display device 580 of a computing device 500 of the individual 402. The self-test results 384 may be conveyed to an individual 402 by audibly stating the self-test results 384 to the individual 402 using the voice activated assistant device 620. The self-test results 384 may be conveyed to an individual 402 by audibly stating the self-test results 384 to the individual 402 using the thermostat 720.

The method 800 may include prior to the receiving the self-test request 388 at the fire detector 310 in block 804 that the self-test request 388 is received from the individual 402 using the voice activated assistant device 620 or the thermostat 720 and the self-test request 388 is transmitted to the fire detector 310. In one embodiment, the self-test request 388 is received by the voice activated assistant device 620. In another embodiment, the self-test request 388 is received by the thermostat 720.

The method 800 may include prior to the receiving the self-test request 388 at the fire detector 310 in block 804 that the self-test request 388 is received from the individual 402 using a computer application 550 on a computing device 500, then the self-test request 388 is transmitted to a cloud-based controller 340, and then the self-test request 388 to the fire detector 310 is transmitted from the cloud-based controller 340.

The method 800 may include prior to the receiving the self-test request 388 at the fire detector 310 in block 804 that the self-test request 388 is initiated on a cloud-based controller 340 and the self-test request 388 is then transmitted to the fire detector 310 from the cloud-based controller 340. The self-test request 388 may be transmitted periodically on a set schedule or sporadically.

While the above description has described the flow process of FIG. 2 in a particular order, it should be appreciated that unless otherwise specifically required in the attached claims that the ordering of the steps may be varied.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

As described above, embodiments can be in the form of processor-implemented processes and devices for practicing those processes, such as a processor. Embodiments can also be in the form of computer program code (e.g., computer program product) containing instructions embodied in tangible media (e.g., non-transitory computer readable medium), such as floppy diskettes, CD ROMs, hard drives, or any other non-transitory computer readable medium, wherein, when the computer program code is loaded into and executed by a computer, the computer becomes a device for practicing the embodiments. Embodiments can also be in the form of computer program code, for example, whether stored in a storage medium, loaded into and/or executed by a computer, or transmitted over some transmission medium, such as over electrical wiring or cabling, through fiber optics, or via electromagnetic radiation, wherein, when the computer program code is loaded into and executed by a computer, the computer becomes a device for practicing the exemplary embodiments. When implemented on a general-purpose microprocessor, the computer program code segments configure the microprocessor to create specific logic circuits.

While the present disclosure has been described with reference to an exemplary embodiment or embodiments, it will be understood by those skilled in the art that various changes may be made and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure not be limited to the particular embodiment disclosed as the best mode contemplated for carrying out this present disclosure, but that the present disclosure will include all embodiments falling within the scope of the claims.

What is claimed is:

1. A method of testing a fire detector, the method comprising:
receiving a self-test request at the fire detector;
initiating a self-test on the fire detector;
emitting a test sound from the fire detector;
detecting the test sound using a voice activated assistant device or a thermostat;
analyzing the test sound;
determining self-test results based on the test sound; and
conveying the self-test results to an individual.

2. The method of claim 1, wherein prior to the receiving the self-test request at the fire detector, the method further comprises:
receiving the self-test request from the individual using the voice activated assistant device or the thermostat; and
transmitting the self-test request to the fire detector.

3. The method of claim 1, wherein prior to the receiving the self-test request at the fire detector, the method further comprises:
receiving the self-test request from the individual using a computer application on a computing device,
transmitting the self-test request to a cloud-based controller; and
transmitting the self-test request to the fire detector from the cloud-based controller.

4. The method of claim 1, wherein prior to the receiving the self-test request at the fire detector, the method further comprises:
initiating the self-test request on a cloud-based controller; and
transmitting the self-test request to the fire detector from the cloud-based controller.

5. The method of claim 1, wherein the test sound is conveyed to a cloud-based controller to analyze the test sound and determine the self-test results.

6. The method of claim 2, wherein the self-test request is received by the voice activated assistant device.

7. The method of claim 2, wherein the self-test request is received by the thermostat.

8. The method of claim 1, wherein the test sound is detected by the voice activated assistant device.

9. The method of claim 1, wherein the test sound is detected by the thermostat.

10. The method of claim 1, wherein the conveying the self-test results to the individual further comprises:
displaying the self-test results on a display device of a computing device of the individual.

11. The method of claim 1, wherein the conveying the self-test results to the individual further comprises:
audibly stating the self-test results to the individual using the voice activated assistant device.

12. The method of claim 1, wherein the conveying the self-test results to the individual further comprises:
audibly stating the self-test results to the individual using the thermostat.

13. The method of claim 1, wherein the self-test includes verifying hardware functional integrity of the fire detector.

14. A computer program product tangibly embodied on a non-transitory computer readable medium, the computer program product including instructions that, when executed by a processor, cause the processor to perform operations comprising:
receiving a self-test request at a fire detector;
initiating a self-test on the fire detector;
emitting a test sound from the fire detector;
detecting the test sound using a voice activated assistant device or a thermostat;
analyzing the test sound;
determining self-test results based on the test sound; and
conveying the self-test results to an individual.

15. The computer program product of claim 14, wherein prior to the receiving the self-test request at the fire detector, the operations further comprise:
receiving the self-test request from the individual using the voice activated assistant device or the thermostat; and
transmitting the self-test request to the fire detector.

16. The computer program product of claim 14, wherein prior to the receiving the self-test request at the fire detector, the operations further comprise:
receiving the self-test request from the individual using a computer application on a computing device,
transmitting the self-test request to a cloud-based controller; and
transmitting the self-test request to the fire detector from the cloud-based controller.

17. The computer program product of claim 14, wherein prior to the receiving the self-test request at the fire detector, the operations further comprise:
initiating the self-test request on a cloud-based controller; and
transmitting the self-test request to the fire detector from the cloud-based controller.

18. The computer program product of claim 14, wherein the test sound is conveyed to a cloud-based controller to analyze the test sound and determine the self-test results.

19. The computer program product of claim 15, wherein the self-test request is received by the voice activated assistant device.

20. The computer program product of claim 15, wherein the self-test request is received by the thermostat.

21. The computer program product of claim 14, wherein the test sound is detected by the voice activated assistant device.
